(19) United States
(12) Patent Application Publication
(10) Pub. No.: US 2025/0061507 A1
(43) Pub. Date: Feb. 20, 2025

(54) METHOD FOR OBTAINING RECOMMENDED EXPLANATION, DEVICE, AND COMPUTER READABLE MEDIUM

(71) Applicants: BEIJING YOUZHUJU NETWORK TECHNOLOGY CO., LTD., PINGGU DISTRICT, BEIJING (CN); LEMON INC., GRAND CAYMAN (KY)

(72) Inventors: Yuanshun YAO, Los Angeles, CA (US); Chong WANG, Los Angeles, CA (US); Hang LI, Beijing (CN)

(21) Appl. No.: 18/722,879

(22) PCT Filed: Jan. 4, 2023
(86) PCT No.: PCT/CN2023/070406

§ 371 Date: Jun. 21, 2024

(30) Foreign Application Priority Data
Jan. 27, 2022 (CN) 202210099915.7

(51) Int. Cl. G06Q 30/0601

(52) U.S. Cl. CPC G06Q 30/0631

(57) ABSTRACT

The present disclosure provides a method for obtaining a recommended explanation, a device, and a computer readable medium. The method includes: generating a recommended item by a recommendation model; calculating a similarity between a plurality of explanatory items and the recommended item; obtaining a predetermined number of explanatory items from the plurality of explanatory items, as a recommended explanation of the recommended item, wherein a similarity between the predetermined number of explanatory items and the recommended item is greater than a similarity between other explanatory items and the recommended item; and outputting identification information of the predetermined number of explanatory items.

### CROSS-REFERENCE TO RELATED APPLICATIONS

The present application is based on and claims priority to China Patent Application No. 202210099915.7 filed on Jan. 27, 2022, the disclosure of which is incorporated by reference herein in its entirety.

### TECHNICAL FIELD

The present disclosure relates to the technical field of recommended explanation, and in particular to a method, device for obtaining a recommended explanation and a computer readable medium.

### BACKGROUND

The necessity for explicable recommendation is a new requirement for recommendation in the industry and a general trend of technology development. An explicable approach of a recommendation system is dedicated to finding recommendation introductions satisfactory to the user subjectively. Since a degree of user satisfaction is a subjective concept, the method for evaluating generated explanations in a recommendation system in the related art mainly depends on user surveys.

### SUMMARY

The summary of the present disclosure is provided to introduce concepts in a concise form, which will be described in detail in the following detailed description. The summary of the present disclosure is neither intended to identify the key features or essential features of the technical solution for which protection is sought, nor intended to limit the scope of the technical solution for which protection is sought.

According to some embodiments of the present disclosure, a method for obtaining a recommended explanation is provided. The method comprises: generating a recommended item by a recommendation model; calculating a similarity between a plurality of explanatory items and the recommended item; obtaining a predetermined number of explanatory items from the plurality of explanatory items, as a recommended explanation of the recommended item, wherein a similarity between the predetermined number of explanatory items and the recommended item is greater than a similarity between other explanatory items and the recommended item; and outputting identification information of the predetermined number of explanatory items.

According to other embodiments of the present disclosure, a device for obtaining a recommended explanation is provided. The device comprises: a generation unit configured to generate a recommended item by a recommendation model; a calculation unit configured to calculate a similarity between a plurality of explanatory items and the recommended item; an obtaining unit configured to obtain a predetermined number of explanatory items from the plurality of explanatory items, as a recommended explanation of the recommended item, wherein a similarity between the predetermined number of explanatory items and the recommended item is greater than a similarity between other explanatory items and the recommended item; and an output unit configured to output identification information of the predetermined number of explanatory items.

According to other embodiments of the present disclosure, an electronic device is provided. The device comprises: a memory; and a processor coupled to the memory having stored therein instructions that, when executed by the processor, cause the electronic device to perform the method according to any one of the embodiments in the present disclosure.

According to other embodiments of the present disclosure, a computer readable storage medium is provided. The storage medium has stored thereon a computer program which, when executed by a processor, implements the method according to any one of the embodiments in the present disclosure.

According to other embodiments of the present disclosure, a computer program is provided. The computer program comprises: instructions that, when executed by a processor, cause the processor to perform the method according to any one of the embodiments in the present disclosure.

Other features, aspects and advantages of the present disclosure will become explicit from the following detailed description of exemplary embodiments of the present disclosure with reference to the accompanying drawings.

### BRIEF DESCRIPTION OF THE ACCOMPANYING DRAWINGS

The embodiments of the present disclosure will be described below with reference to the accompanying drawings. The accompanying drawings described herein are used to provide a further understanding of the present disclosure, and each of the accompanying drawings together with the following detailed description is comprised in this specification and forms a part of this specification to explain the present disclosure. It should be understood that, the accompanying drawings in the following description only relate to some embodiments of the present disclosure, but do not constitute a limitation to the present disclosure. In the accompanying drawings:

FIG. 1 is a flowchart showing a recommended explanation generated by a recommendation system according to some embodiments of the present disclosure;

FIG. 2 is a flowchart showing a method for obtaining a recommended explanation according to some embodiments of the present disclosure;

FIG. 3 is a flowchart showing a method for obtaining a recommended explanation according to other embodiments of the present disclosure;

FIG. 4 is a flowchart showing a method for obtaining a recommended explanation according to other embodiments of the present disclosure;

FIG. 5 is a schematic view showing a counterfactual degree of a quantitative explanation according to some embodiments of the present disclosure;

FIG. 6 is a flowchart showing a method for obtaining a recommended explanation according to other embodiments of the present disclosure;

FIG. 7 is a structural block diagram showing a device for obtaining a recommended explanation according to some embodiments of the present disclosure;

FIG. 8 is a block diagram showing a structure of an electronic device according to some embodiments of the present disclosure;

FIG. 9 is a block view showing an example structure of a computer system that may be employed in an embodiment of the present disclosure.

It should be understood that, for ease of description, the sizes of various parts shown in the accompanying drawings are not necessarily drawn according to actual proportional relationships. The same or similar reference numerals are used in various accompanying drawings to denote the same or similar components. Therefore, once an item is defined in one accompanying drawing, it might not be discussed further in subsequent accompanying drawings.

### DETAILED DESCRIPTION

The technical solutions in the embodiments of the present disclosure will be explicitly and completely described below in conjunction with the accompanying drawings in the embodiments of the present disclosure. However, it is apparent that the described embodiments are only a part of the embodiments of the present disclosure, rather than all the embodiments. The following description of the embodiments is actually only illustrative, and by no means serves as any limitation to the present disclosure and its application or use. It should be understood that the present disclosure may be implemented in various forms, and should not be construed as being limited to the embodiments set forth herein.

It should be understood that the various steps recited in the method embodiments of the present disclosure may be performed according to different sequences, and/or performed in parallel. In addition, the method embodiments may comprise additional steps and/or omit to perform the illustrated steps. The scope of the present disclosure is not limited in this respect. Unless specifically stated otherwise, the relative arrangement of components and steps, the numerical expressions, and the values set forth in these embodiments should be construed as merely exemplary, but do not limit the scope of the present disclosure.

The term “comprising” and its variations used in the present disclosure represent an open term that comprises at least the following elements/features but does not exclude other elements/features, that is, “comprising but not limited to”. In addition, the term “including” and its variations used in the present disclosure represent an open term that includes at least the following elements/features, but does not exclude other elements/features, that is, “including but not limited to”. Therefore, comprising and including are synonymous. The term “based on” means “at least partially based on”.

The term “one embodiment”, “some embodiments” or “an embodiment” throughout the specification means that a specific feature, structure, or characteristic described in combination with the embodiment(s) is comprised in at least one embodiment of the present invention. For example, the term “one embodiment” means “at least one embodiment”; the term “another embodiment” means “at least one additional embodiment”; and the term “some embodiments” means “at least some embodiments”. Moreover, the presences of the phrases “in one embodiment”, “in some embodiments” or “in an embodiment” in various places throughout the specification do not necessarily all refer to the same embodiment, but may also refer to the same embodiment.

It should be noted that the concepts such as “first” and “second” mentioned in the present disclosure are only used to distinguish different devices, modules or units, but not to limit the order or interdependence of functions performed by these devices, modules or units. Unless otherwise specified, the concepts such as “first” and “second” are not intended to imply that the objects thus described have to follow a given order in terms of time, space and ranking, or a given order in any other manner.

It should be noted that the modifications of “one” and “a plurality of” mentioned in the present disclosure are illustrative rather than restrictive, and those skilled in the art should understand that they should be understood as “one or more” unless contextually specified otherwise.

The names of messages or information exchanged between multiple devices in the embodiments of the present disclosure are only used for illustrative purposes, but not for limiting the scope of these messages or information.

The embodiments of the present disclosure will be described in detail below in conjunction with the accompanying drawings, but the present disclosure is not limited to these specific embodiments. The following specific embodiments may be combined with each other, and the same or similar concepts or processes will not be described in detail in some embodiments. In addition, in one or more embodiments, specific features, structures, or characteristics may be combined by those of ordinary skill in the art in any suitable manner that will be apparent from the present disclosure.

The method for evaluating generated explanations in a recommendation system in the related art mainly depends on user surveys, so that it is generally very expensive and takes a long time, with a low accuracy in explaining a recommended item for a user.

In view of this, the embodiment of the present disclosure provides a method for obtaining a recommended explanation to improve the accuracy in explaining a recommended item by using an explanatory item, so that the recommendation system can explain a recommended item more accurately for a user.

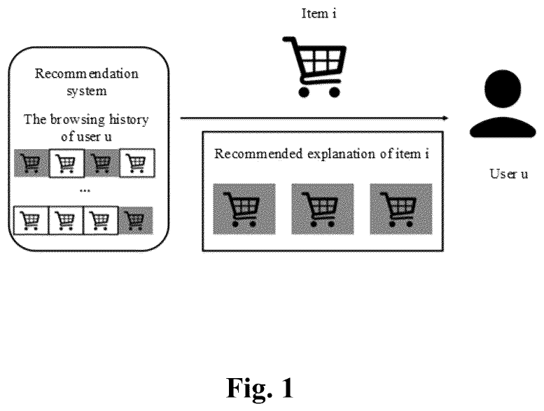

FIG. 1 is a flowchart showing a recommended explanation generated by a recommendation system according to some embodiments of the present disclosure.

Suppose there are m (m is a positive integer) users in the recommendation system: user set U={u₁, . . . , uₘ}, n (n is a positive integer) items: item set I={i₁, . . . , iₙ}, and all the past interaction history between a user and an item: S ⊆U×I. For a user u, the interaction history of the user is Iᵤ={i ∈I: (u,i) ∈S}, that is, Iᵤ is the subset of I, and Iᵤ is the set of all items that the user u has interacted with. As shown in FIG. 1, assuming that the recommendation model θ recommends the item i to the user u, the recommendation system may demonstrate a part of the previously interacted items E_{u,i} (E_{u,i} ⊆Iᵤ) to the user u as a recommended explanation.

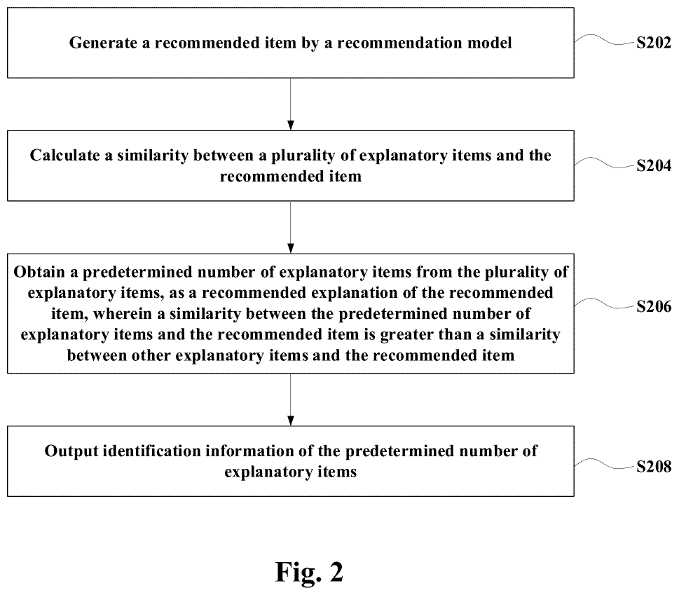

FIG. 2 is a flowchart showing a method for obtaining a recommended explanation according to some embodiments of the present disclosure. As shown in FIG. 2, the method comprises steps S202 to S208.

In step S202, a recommended item is generated by a recommendation model. For example, identification information (i.e., ID information) of a plurality of explanatory items is input to the recommendation model to generate a recommended item.

Here, the recommended item is an item recommended to a user, and the explanatory item is an item used to explain a reason for recommending an item to a user. The recommendation model may use a known recommendation model.

In step S204, a similarity between a plurality of explanatory items and the recommended item is calculated.

In some embodiments, a Euclidean distance in a feature vector space may be used to characterize a similarity between the explanatory item and the recommended item.

For example, the above-described step S204 comprises: obtaining a feature vector of each of the plurality of explanatory items and a feature vector of the recommended item from the recommendation model; and calculating a Euclidean distance between the feature vector of each of the plurality of explanatory items and the feature vector of the recommended item, the similarity between the each of the plurality of explanatory items and the recommended item being characterized by the Euclidean distance, wherein the less the Euclidean distance, the greater the similarity. In this embodiment, the similarity between the explanatory item and the recommended item is evaluated by using the Euclidean distance to facilitate obtaining an appropriate explanatory item accurately in subsequent steps, so as to explain a recommended item more accurately for a user.

In other embodiments, the similarity between the plurality of explanatory items and the recommended item is characterized by a counterfactual similarity (i.e., counterfactual proximity).

In some embodiments, the method further comprises: before calculating the similarity between the plurality of explanatory items and the recommended item, removing at least a portion of the plurality of explanatory items from a training set, and training the recommendation model by remaining items in the training set; calculating a loss function value of the recommendation model during each training process; and determining a recommendation model with a smallest loss function value as a trained recommendation model. For example, the training set is a set I of all items in a system (i.e., a recommendation system) where the recommendation model is located.

In some embodiments, the characterizing of the similarity between the plurality of explanatory items and the recommended item by the counterfactual proximity comprises: calculating the counterfactual proximity P_{c} between the plurality of explanatory items and the recommended item by the trained recommendation model:

$${P}_{C} = {max}_{j ∈ I \backslash \{ i \}} f ( j ; {θ}^{′} ) - f ( i ; {θ}^{′} ) , \qquad ( 1 )$$

wherein i is the recommended item, I is a set of all items in a system (i.e., the recommendation system) where the recommendation model is located, I\{i} is a set of remaining items in the set I of all items except the recommended item i, f(j; θ′) is a predicted recommendation score (here, the higher recommendation score represents that the item should be more recommended) for an item j calculated by a recommendation model θ′, f(i; θ′) is a predicted recommendation score for an item i calculated by the recommendation model θ′, and θ′ is the trained recommendation model.

$${max}_{j ∈ I \backslash \{ i \}} f ( j ; {θ}^{′} )$$

f(j; θ′) represents a maximum value of f(j; θ′).

In above-described embodiments, the similarity between the explanatory item and the recommended item is evaluated by using the counterfactual proximity, so that it is possible to facilitate obtaining an appropriate explanatory item accurately in subsequent steps, so as to explain a recommended item more accurately for a user.

In step S206, a predetermined number of explanatory items are obtained from the plurality of explanatory items, the predetermined number of explanatory items being used as a recommended explanation of the recommended item, wherein a similarity between the predetermined number of explanatory items and the recommended item is greater than a similarity between other explanatory items and the recommended item.

For example, for a case where the similarity between the explanatory item and the recommended item is characterized by the Euclidean distance, the above-described step S206 comprises: selecting the predetermined number of explanatory items from the plurality of explanatory items, a Euclidean distance between a feature vector of each of the predetermined number of explanatory items and the feature vector of the recommended item being less than a Euclidean distance between a feature vector of each of other explanatory items (i.e., explanatory items other than the predetermined number of explanatory items in the plurality of explanatory items) and the feature vector of the recommended item.

For another example, for a case where the similarity between the plurality of explanatory items and the recommended item is characterized by the counterfactual proximity, the above-described step S206 comprises: in response to the predetermined number |E_{u,i}| of the explanatory items being fixed, traversing C_{|I}_{ᵤ}_{|}^{|E}^{_{u,i}}^{|} (or expressed as

$$( \begin{matrix}\vert {I}_{u} \vert \\ \vert {E}_{u , i} \vert\end{matrix} ) )$$

combinations of explanatory items, calculating the counterfactual proximity corresponding to each combination of explanatory items, and obtaining a combination of explanatory items with a largest counterfactual proximity, wherein Iᵤ is the set of all items that an user u interacts with, and E_{u,i} is a set of a part of the items that the user interacts with.

In step S208, identification information of the predetermined number of explanatory items is output.

For example, for a case where the similarity between the explanatory item and the recommended item is characterized by the Euclidean distance, identification information of the selected predetermined number of explanatory items is output.

For another example, for a case where the similarity between the plurality of explanatory items and the recommended item is characterized by the counterfactual proximity, identification information of a combination of explanatory items with a largest counterfactual proximity is output.

Here, the output predetermined number of explanatory items are used as an explanation of the recommended item.

So far, a method for obtaining a recommended explanation according to some embodiments of the present disclosure is provided. The method comprises: generating a recommended item by a recommendation model; calculating a similarity between a plurality of explanatory items and the recommended item; obtaining a predetermined number of explanatory items from the plurality of explanatory items, as a recommended explanation of the recommended item, wherein a similarity between the predetermined number of explanatory items and the recommended item is greater than a similarity between other explanatory items and the recommended item; and outputting identification information of the predetermined number of explanatory items. The method improves the accuracy in explaining a recommended item by using an explanatory item, so that the recommendation system may explain a recommended item more accurately for a user. The above-described method improves a degree of user satisfaction with a generated explanation. In addition, the above-described method involves less cost and is less time-consuming.

In some embodiments, the method further comprises: outputting the similarity between the predetermined number of explanatory items and the recommended item.

For example, for a case where the similarity between the explanatory item and the recommended item is characterized by the Euclidean distance, the outputting of the similarity between the predetermined number of explanatory items and the recommended item comprises: calculating an average of Euclidean distances between feature vectors of the predetermined number of explanatory items and the feature vector of the recommended item; and outputting the average of Euclidean distances.

The average d(E_{u,i}, i) of the Euclidean distance between the feature vector of the explanatory item and the feature vector of the recommended item is as follows:

$$d ( {E}_{u , i} , i ) = \frac{1}{\vert {E}_{u i} \vert} {Σ}_{j ∈ {E}_{u , i}} {‖ ∅ ( i ) - ∅ ( j ) ‖}_{2} , \qquad ( 2 )$$

ϕ(·) is an embedding space characterization of the item, ∥Ø(i)−Ø(j)∥₂ is the Euclidean distance between the feature vector of the explanatory item j and the feature vector of the recommended item i.

For another example, for a case where the similarity between the plurality of explanatory items and the recommended item is characterized by the counterfactual proximity, the outputting of the similarity between the predetermined number of explanatory items and the recommended item comprises: outputting a maximum value of the counterfactual proximity. That is, the counterfactual proximity corresponding to a combination of explanatory items with a largest counterfactual proximity is output.

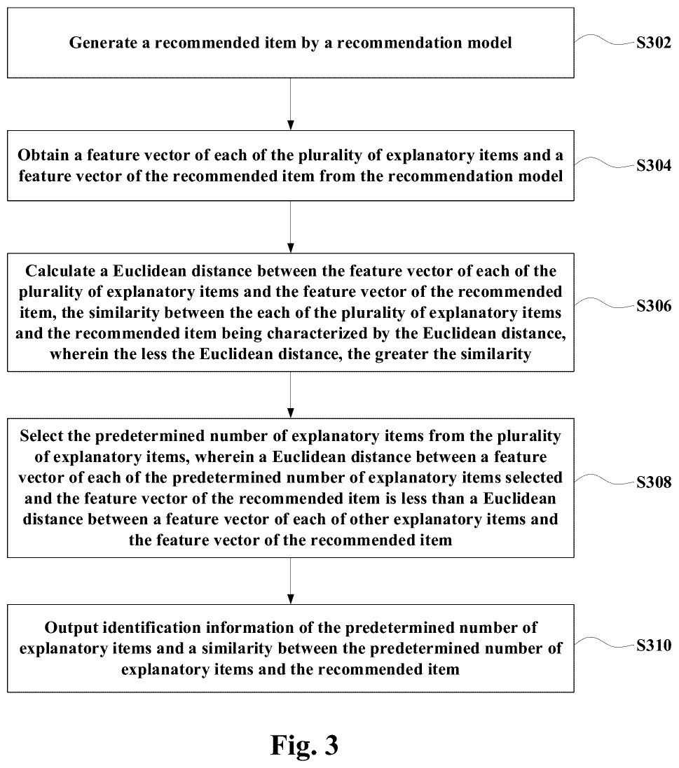

FIG. 3 is a flowchart showing a method for obtaining a recommended explanation according to other embodiments of the present disclosure. The method describes a method of characterizing the similarity between the explanatory item and the recommended item by the Euclidean distance. As shown in FIG. 3, the method comprises steps S302 to S310.

In step S302, a recommended item is generated by a recommendation model. For example, the recommendation model may generate a recommended item after receiving identification information of a plurality of explanatory items.

In step S304, a feature vector of each of the plurality of explanatory items and a feature vector of the recommended item are obtained from the recommendation model. That is, in addition to generating a recommended item, the recommendation model may also generate the feature vector of each of the plurality of explanatory items and the feature vector of the recommended item.

In step S306, a Euclidean distance between the feature vector of each of the plurality of explanatory items and the feature vector of the recommended item is calculated, the similarity between the each of the plurality of explanatory items and the recommended item being characterized by the Euclidean distance, wherein the less the Euclidean distance, the greater the similarity.

In step S308, a predetermined number of explanatory items are selected from the plurality of explanatory items, wherein a Euclidean distance between a feature vector of each of the predetermined number of explanatory items selected and the feature vector of the recommended item is less than a Euclidean distance between a feature vector of each of other explanatory items and the feature vector of the recommended item.

In step S310, identification information of the predetermined number of explanatory items and a similarity between the predetermined number of explanatory items and the recommended item are output.

For example, an average of Euclidean distances between feature vectors of the predetermined number of explanatory items and the feature vector of the recommended item is calculated, wherein the average of Euclidean distances characterizes a similarity between the predetermined number of explanatory items and the recommended item; and identification information of the predetermined number of explanatory items and the average of Euclidean distances are output.

So far, a method for obtaining a recommended explanation according to some embodiments of the present disclosure is provided. In the method, the similarity between the explanatory item and the recommended item is measured by measuring the Euclidean distance between the explanatory item and the recommended item in the item embedding space (the item embedding space is generated by the recommendation model and the item is represented by the feature vector), so as to find a predetermined number of explanatory items closest to the recommended item as a recommended explanation and output the recommended explanation. This improves the accuracy in explaining a recommended item by using an explanatory item, so that the recommendation system can explain a recommended item more accurately for a user. The calculation speed of the method is very fast, and a degree of user satisfaction with a generated explanation is improved.

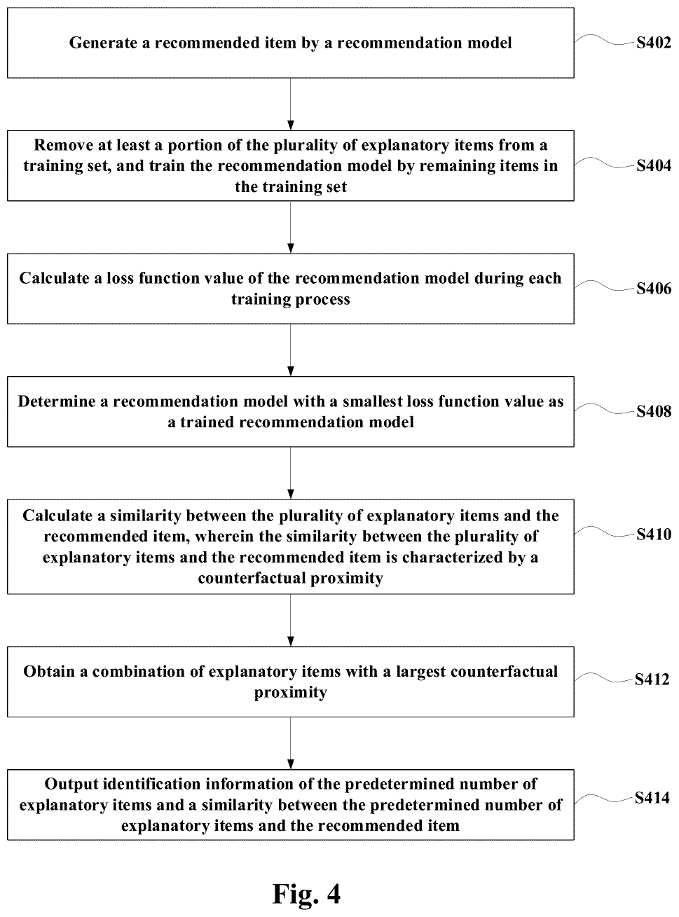

FIG. 4 is a flowchart showing a method for obtaining a recommended explanation according to other embodiments of the present disclosure. The method describes a method of characterizing the similarity between the explanatory item and the recommended item by the counterfactual proximity. As shown in FIG. 4, the method comprises steps S402 to S414.

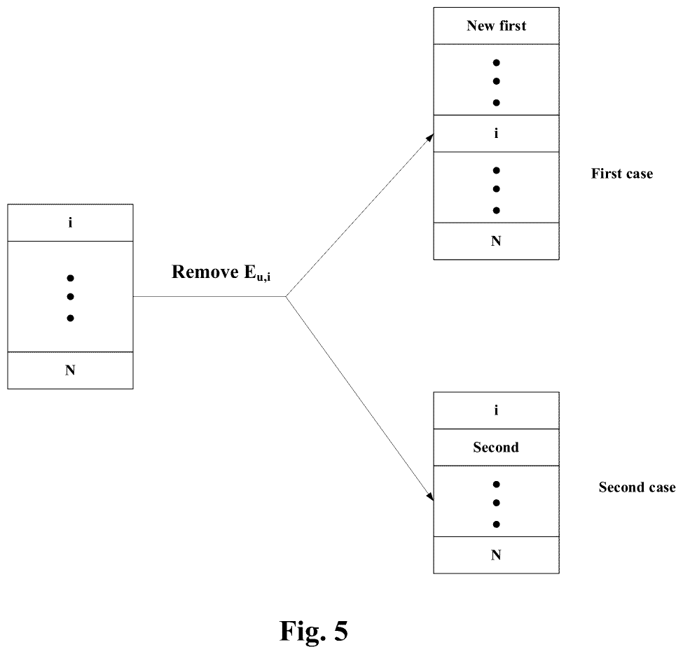

Here, a counterfactual definition will be first introduced in conjunction with FIG. 5, and then the method shown in FIG. 4 will be described. For example, when the recommendation system recommends a user to view a video (as a recommended item), the system might explain that “this video will not be recommended if the previous three videos have not been watched in the past”. That is, with an explanation E_{u,i} given, the explanation may be removed from the user interaction history Iᵤ, and the recommendation model is trained again. Then, how the predicted recommendation score of the model varies is observed.

As shown in FIG. 5, suppose that E_{u,i} is removed from the training set and the recommendation model is trained again.

For a first case, in the new counterfactual sorting, if the previously recommended item i cannot remain in the original first place, it represents that E_{u,i} is counterfactual. In other words, if there is no E_{u,i}, then the system will not provide a current recommended item i, thus indicating that E_{u,i} is important to the current recommended item i. Therefore, the more counterfactual E_{u,i}, the less likely for the recommended item i to remain in the first place.

For a second case, after removing E_{u,i} from the training set and training the recommendation model again, the item i still remains in the first place, which indicates that E_{u,i} is not very important to the current recommended item i. When the item i is close to the second item, the item i might be replaced by the second item.

Here, f(i; θ) is used to represents the predicted recommendation score of the item i calculated by the recommendation model θ. The scope of the present disclosure is not limited to the specific form of the f(i; θ). The counterfactual approximation P_{c} is defined as follows:

$${P}_{C} ( {E}_{u , i} , i ) = {max}_{j ∈ I ∖ \{ i \}} f ( j ; {θ}^{′} ) - f ( i ; {θ}^{′} ) , \qquad ( 1 )$$

$$wherein {θ}^{′} = {arg min}_{θ ∈ Θ} {\sum }_{( {u}^{′} , {i}^{′} ) ∈ S ∖ \{ u \times {E}_{u , i} \}} ℓ ( {u}^{′} , {i}^{′} ; θ ) . \qquad ( 3 )$$

wherein i is the recommended item, I is a set of all items in a system where the recommendation model is located, I\{i} is a set of remaining items in the item set I except the recommended item i, f(j; θ′) is a predicted recommendation score for an item j calculated by a recommendation model θ′, f(i; θ′) is a predicted recommendation score for an item i calculated by the recommendation model θ′, θ′ is the trained recommendation model; S\{u×E_{u,i}} is the remaining set after removing {u×E_{u,i}} from the set S

Here, the greater counterfactual proximity means the greater similarity between the explanatory item and the recommended item, that is, a recommended item explained by using an explanatory item is more likely to be accepted by a user.

The definition of the counterfactual proximity has been explained above, and next returning to FIG. 4, the method for obtaining the recommended explanation according to other embodiments of the present disclosure will be described in conjunction with FIG. 4.

As shown in FIG. 4, in step S402, a recommended item is generated by a recommendation model.

In step S404, at least a portion (for example, E_{u,i} described previously) of the plurality of explanatory items is removed from a training set, and the recommendation model is trained by using remaining items in the training set. For example, the training set is the set I described previously.

In step S406, a loss function value of the recommendation model during each training process is calculated.

In step S408, a recommendation model with a smallest loss function value is determined as a trained recommendation model. Here, the steps S404 to S408 describe the process of the above-described condition 3.

In step S410, a similarity between the plurality of explanatory items and the recommended item is calculated, wherein the similarity between the plurality of explanatory items and the recommended item is characterized by a counterfactual proximity.

In step S412, a combination of explanatory items with a largest counterfactual proximity is obtained. For example, in response to the predetermined number |E_{u,i}| of the explanatory items being fixed, C_{|I}_{ᵤ}_{|}^{|E}^{_{u,i}}^{|} combinations of explanatory items are transversed, the counterfactual proximity corresponding to each combination of explanatory items is calculated, and a combination of explanatory items with a largest counterfactual proximity is obtained.

In step S414, identification information of the predetermined number of explanatory items and a similarity between the predetermined number of explanatory items and the recommended item are output.

For example, a combination of explanatory items with a largest counterfactual proximity and the counterfactual proximity corresponding to the combination of explanatory items, that is, a maximum value of the counterfactual proximity, are output.

So far, a method for obtaining a recommended explanation according to some embodiments of the present disclosure is provided. In the method, the similarity between the explanatory item and the recommended item is characterized by the counterfactual proximity. By way of the method, a combination of explanatory items with a largest counterfactual proximity can be found to improve the accuracy in explaining a recommended item by using an explanatory item, so that the recommendation system can explain a recommended item more accurately for a user, and the method makes it easier for a user to understand the recommended explanation. The above-described method improves a degree of user satisfaction with a generated explanation.

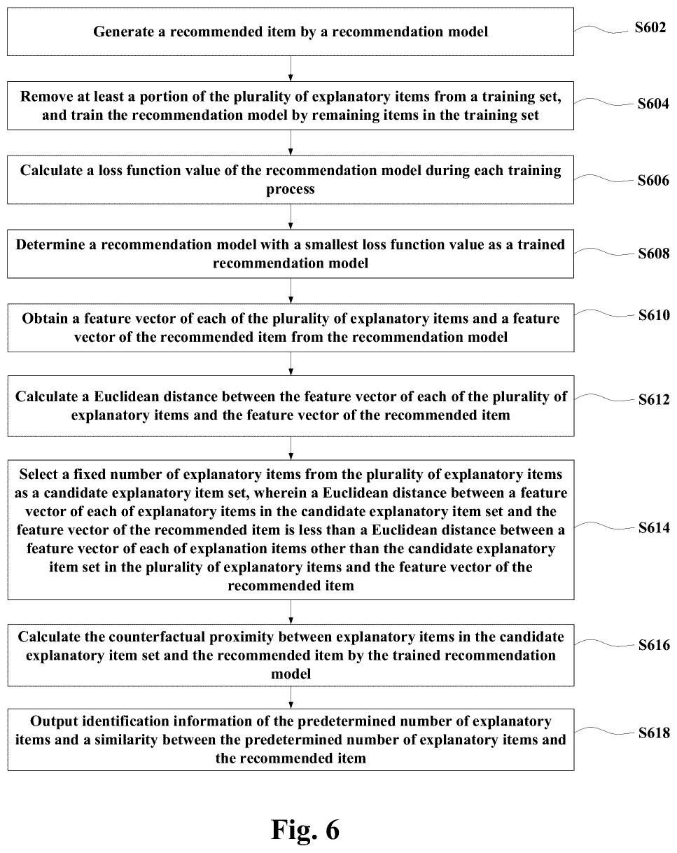

In some embodiments, the methods shown in FIG. 3 and FIG. 4 may be mixed in use. That is, some possible candidate explanations are first generated by the method shown in FIG. 3 (which may be referred to as the nearest neighbor method) to form a set of candidate explanations, and then a recommended explanation is further selected by the counterfactual method on the set of candidate explanations. The method improves the calculation speed, and also makes it easier for a user to understand the recommended explanation. The mixing method will be described in detail below in conjunction with FIG. 6.

FIG. 6 is a flowchart showing a method for obtaining a recommended explanation according to other embodiments of the present disclosure. As shown in FIG. 6, the method comprises steps S602 to S604.

In step S602, a recommended item is generated by a recommendation model.

In step S604, at least a portion (for example, E_{u,i} described previously) of a plurality of explanatory items is removed from a training set, and the recommendation model is trained by using remaining items in the training set.

In step S606, a loss function value of the recommendation model during each training process is calculated.

In step S608, a recommendation model with a smallest loss function value is determined as a trained recommendation model.

In step S610, a feature vector of each of the plurality of explanatory items and a feature vector of the recommended item is obtained from the recommendation model.

In step S612, a Euclidean distance between the feature vector of each of the plurality of explanatory items and the feature vector of the recommended item is calculated.

In step S614, a fixed number of explanatory items are selected from the plurality of explanatory items as a candidate explanatory item set, wherein a Euclidean distance between a feature vector of each of explanatory items in the candidate explanatory item set and the feature vector of the recommended item is less than a Euclidean distance between a feature vector of each of explanation items other than the candidate explanatory item set in the plurality of explanatory items and the feature vector of the recommended item.

In step S616, the counterfactual proximity between explanatory items in the candidate explanatory item set and the recommended item is calculated by the trained recommendation model.

The above-described steps S610 to S616 describe a process of calculating a similarity between a plurality of explanatory items and the recommended item.

In step S618, identification information of the predetermined number of explanatory items and a similarity between the predetermined number of explanatory items and the recommended item are output. That is, identification information of the predetermined number of explanatory items and a maximum value of the counterfactual proximity are output.

For example, a predetermined number of explanatory items may be first obtained from the plurality of explanatory items, and then identification information of the predetermined number of explanatory items and a similarity between the predetermined number of explanatory items and the recommended item are output.

In some embodiments, the obtaining of the predetermined number of explanatory items from the plurality of explanatory items comprises: in response to the predetermined number |E_{u,i}| of the explanatory items being fixed, traversing C_{|I}_{_{c}}_{|}^{|E}^{_{u,i}}^{|} combinations of explanatory items, calculating the counterfactual proximity corresponding to each combination of explanatory items, and obtaining a combination of explanatory items with a largest counterfactual proximity, wherein I_{c} is the candidate explanatory item set, and E_{u,i} is a set of a part of the items that the user interacts with.

So far, a method for obtaining a recommended explanation according to some embodiments of the present disclosure is provided. Since the method mixes the two methods described previously, the method improves the calculation speed, and also makes it easier for a user to understand the recommended explanation. The above-described method improves a degree of user satisfaction with a generated explanation.

In other embodiments, the similarity between the plurality of explanatory items and the recommended item comprises: a similarity between tags of the plurality of explanatory items and a tag of the recommended item, a similarity between features of the plurality of explanatory items and a feature of the recommended item, a similarity between reviews of the plurality of explanatory items and a review of the recommended item, or a similarity of user feedback information of the plurality of explanatory items and user feedback information of the recommended item. In other words, any method of calculating a distance between items can be used in the method of the present disclosure, comprising but not limited to the similarity between item tags, the similarity between item features, the similarity between item reviews, the similarity between user feedback of items, or the like.

Calculation formulas of the above-described similarities such as of item tags may be the same as the previous Euclidean distance formula, or other calculation methods may also be used, for example by directly using the coincidence degree of item tags.

As to which similarity to be selected, it may depend on a recommended scenario. For example, in the movie recommendation, it may be the coincidence degree of tags of movie types (for example, action films or comedy films), or in the shopping recommendation, it may be the coincidence degree of item classifications (electrical appliances, furniture, etc.).

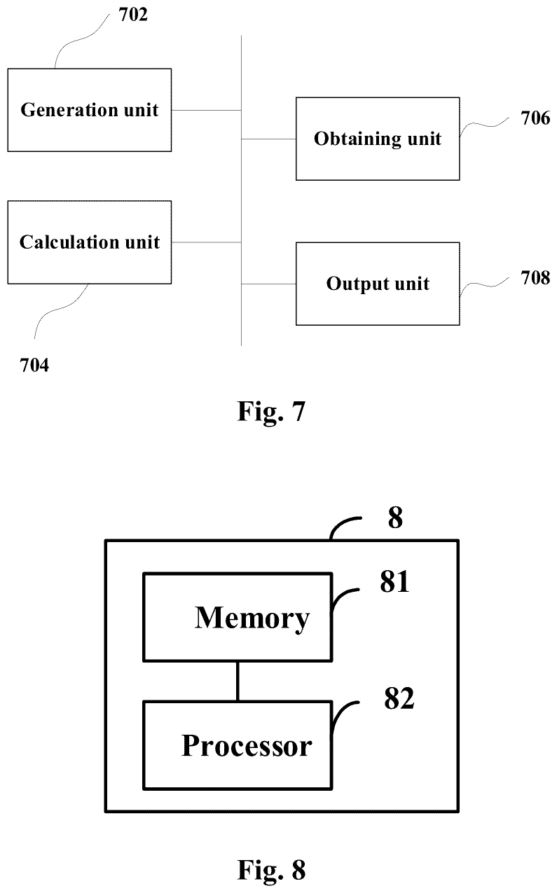

FIG. 7 is a structural block diagram showing a device for obtaining a recommended explanation according to some embodiments of the present disclosure. As shown in FIG. 7, the device comprises a generation unit 702, a calculation unit 704, an obtaining unit 706 and an output unit 708.

The a generation unit 702 is configured to generate a recommended item by a recommendation model.

The calculation unit 704 is configured to calculate a similarity between a plurality of explanatory items and the recommended item.

The obtaining unit 706 is configured to obtain a predetermined number of explanatory items from the plurality of explanatory items, as a recommended explanation of the recommended item, wherein a similarity between the predetermined number of explanatory items and the recommended item is greater than a similarity between other explanatory items and the recommended item.

The output unit 708 is configured to output identification information of the predetermined number of explanatory items.

So far, a device for obtaining a recommended explanation according to other embodiments of the present disclosure is provided. The device improves the accuracy in explaining a recommended item by using an explanatory item, so that the recommendation system can explain a recommended item more accurately for a user. The above-described device improves a degree of user satisfaction with a generated explanation.

In some embodiments, the output unit 708 is further configured to output the similarity between the predetermined number of explanatory items and the recommended item.

In some embodiments, the calculation unit 704 is configured to obtain a feature vector of each of the plurality of explanatory items and a feature vector of the recommended item from the recommendation model, and calculate a Euclidean distance between the feature vector of each of the plurality of explanatory items and the feature vector of the recommended item, the similarity between the each of the plurality of explanatory items and the recommended item being characterized by the Euclidean distance, wherein the less the Euclidean distance, the greater the similarity.

In some embodiments, the obtaining unit 706 is configured to select the predetermined number of explanatory items from the plurality of explanatory items, wherein a Euclidean distance between a feature vector of each of the predetermined number of explanatory items and the feature vector of the recommended item is less than a Euclidean distance between a feature vector of each of other explanatory items and the feature vector of the recommended item.

In some embodiments, the output unit 708 is configured to calculate an average of Euclidean distances between feature vectors of the predetermined number of explanatory items and the feature vector of the recommended item, and output the average of Euclidean distances.

In other embodiments, the calculation unit 704 is configured to characterize the similarity between the plurality of explanatory items and the recommended item by a counterfactual proximity.

In some embodiments, the device further comprises a training unit. The training unit is configured to remove at least a portion of the plurality of explanatory items from a training set, train the recommendation model by remaining items in the training set, calculate a loss function value of the recommendation model during each training process, and determine a recommendation model with a smallest loss function value as a trained recommendation model.

In some embodiments, the calculation unit 704 is configured to calculate the counterfactual proximity P_{c} between the plurality of explanatory items and the recommended item by the trained recommendation model:

$${P}_{C} = {max}_{j ∈ I \backslash \{ i \}} f ( j ; {θ}^{′} ) - f ( i ; {θ}^{′} ) ,$$

wherein i is the recommended item, I is a set of all items in a system where the recommendation model is located, I\{i} is a set of remaining items in the set I of all items except the recommended item i, f(j; θ′) is a predicted recommendation score for an item j calculated by a recommendation model θ′, f(i; θ′) is a predicted recommendation score for an item i calculated by the recommendation model θ′, and θ′ is the trained recommendation model.

In other embodiments, the obtaining unit 706 is configured to, in response to the predetermined number |E_{u,i}| of the explanatory items being fixed, traverse C_{|I}_{ᵤ}_{|}^{|E}^{_{u,i}}^{|} combinations of explanatory items, calculate the counterfactual proximity corresponding to each combination of explanatory items, and obtain a combination of explanatory items with a largest counterfactual proximity, wherein Iᵤ is the set of all items that an user u interacts with, and E_{u,i} is a set of a part of the items that the user interacts with.

In other embodiments, the calculation unit 704 is configured to obtain a feature vector of each of the plurality of explanatory items and a feature vector of the recommended item from the recommendation model, calculate a Euclidean distance between the feature vector of each of the plurality of explanatory items and the feature vector of the recommended item, selecting a fixed number of explanatory items from the plurality of explanatory items as a candidate explanatory item set, wherein a Euclidean distance between a feature vector of each of explanatory items in the candidate explanatory item set and the feature vector of the recommended item is less than a Euclidean distance between a feature vector of each of explanation items other than the candidate explanatory item set in the plurality of explanatory items and the feature vector of the recommended item, and calculate the counterfactual proximity between explanatory items in the candidate explanatory item set and the recommended item by the trained recommendation model.

In other embodiments, the obtaining unit 706 is configured to, in response to the predetermined number |E_{u,i}| of the explanatory items being fixed, traverse C_{|I}_{_{c}}_{|}^{|E}^{_{u,i}}^{|} combinations of explanatory items, calculate the counterfactual proximity corresponding to each combination of explanatory items, and obtain a combination of explanatory items with a largest counterfactual proximity, wherein I_{c} is the candidate explanatory item set, and E_{u,i} is a set of a part of the items that the user interacts with.

In other embodiments, the output unit 708 is configured to output a maximum value of the counterfactual proximity.

In some embodiments, the similarity between the plurality of explanatory items and the recommended item comprises: a similarity between tags of the plurality of explanatory items and a tag of the recommended item, a similarity between features of the plurality of explanatory items and a feature of the recommended item, a similarity between reviews of the plurality of explanatory items and a review of the recommended item, or a similarity of user feedback information of the plurality of explanatory items and user feedback information of the recommended item.

It should be noted that, the above-described units are only logical modules divided according to the specific functions realized by the same, but not intended to limit specific implementations. For example, it is possible to be implemented in the form of software, hardware, or a combination of software and hardware. In actual implementation, each of the above-described units may be implemented as an independent physical entity, or may also be implemented by a single entity (for example, a processor (CPU or DSP, and the like), an integrated circuit, etc.). In addition, the operations/functions implemented by the above-described units may be implemented by the processing circuit itself.

In addition, although not shown, the device may also comprise a memory, which may store various information generated by the device and various units comprised in the device during operation, programs and data for operation, data to be sent by the communication unit, and the like. The memory may be a volatile memory and/or a non-volatile memory. For example, the memory may comprise, but is not limited to, a random access memory (RAM), a dynamic random access memory (DRAM), a static random access memory (SRAM), a read only memory (ROM), and a flash memory. Of course, the memory may also be located outside the device. Alternatively, although not shown, the device may also comprise a communication unit, which may be used to communicate with other devices. In one example, the communication unit may be implemented in an appropriate manner known in the art, for example, comprising communication components such as antenna arrays and/or radio frequency links, various types of interfaces, communication units, and the like, which will not be described in detail here. Detailed description will not be repeated here. In addition, the device may also comprise other components not shown, such as a radio frequency link, a baseband processing unit, a network interface, a processor, a controller, and the like. Detailed description will not be repeated here.

In some embodiments of the present disclosure, an electronic device is also provided. FIG. 8 is a block diagram showing a structure of an electronic device according to some embodiments of the present disclosure. For example, in some embodiments, the electronic device 8 which may be various types of devices, for example may comprise, but is not limited to mobile terminals such as mobile phones, notebook computers, digital broadcast receivers, PDAs (personal digital assistants), PADs (tablet computers), PMP (Portable Multimedia Player) and in-vehicle terminals (for example, in-vehicle navigation terminals); and fixed terminals such as digital TVs, desktop computers or the like. For example, the electronic device 8 may comprise a display panel for displaying data and/or execution results used in the solution according to the present disclosure. For example, the display panel may have various shapes, such as a rectangular panel, an oval panel, a polygonal panel, or the like. In addition, the display panel may be not only a flat panel, but also a curved panel, or even a spherical panel.

As shown in FIG. 8, the electronic device 8 of this embodiment comprises: a memory 81, and a processor 82 coupled to the memory 81. It should be noted that the components of the electronic device 8 shown in FIG. 8 are only exemplary, but not restrictive. According to actual application requirements, the electronic device 8 may also have other components. The processor 82 may control other components in the electronic device 8 to perform desired functions.

In some embodiments, the memory 81 is configured to store one or more computer-readable instructions. When the processor 82 is configured to run computer-readable instructions, the computer-readable instructions are executed by the processor 82 to implement the method according to any of the above-described embodiments. For the specific implementation of each step of the method and the related explanation content, it is possible to refer to the above-described embodiments, which will not be described in detail here.

For example, the processor 82 and the memory 81 may directly or indirectly communicate with each other. For example, the processor 82 and the memory 81 may communicate through a network. The network may comprise a wireless network, a wired network, and/or any combination of a wireless network and a wired network. The processor 82 and the memory 81 may also communicate with each other through a system bus, which is not limited in the present disclosure.

For example, the processor 82 may be embodied as various appropriate processors, processing devices and the like, such as a central processing unit (CPU), a graphics processing unit (GPU) or a network processor (NP); and may also be a digital signal processor (DSP), an application specific integrated circuit (ASIC), a field programmable gate array (FPGA) or other programmable logic devices, a discrete gate or transistor logic device, and a discrete hardware component. The central processing unit (CPU) may be X86 or ARM architecture and the like. For example, the memory 81 may comprise any combination of various forms of computer-readable storage media, such as a volatile memory and/or a non-volatile memory. The memory 81 may comprise, for example, a system memory. The system memory, for example, stores an operating system, an application program, a boot loader, a database, and other programs. Various application programs and various data may also be stored in the storage medium.

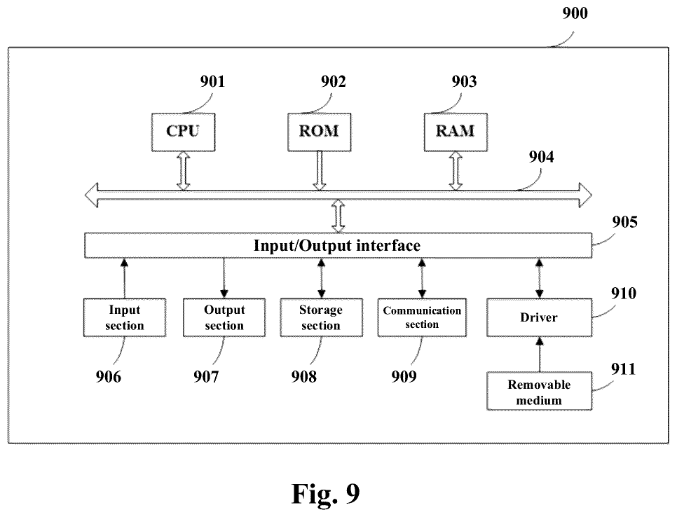

In addition, according to some embodiments of the present disclosure, in a case that various operations/processes according to the present disclosure are implemented by software and/or firmware, a program constituting the software can be installed from a storage medium or a network to a computer system with a dedicated hardware structure, such as the computer system 900 shown in FIG. 9. When the computer system is installed with various programs, it is possible to perform various functions, comprising the functions described above. FIG. 9 is a block view showing an example structure of a computer system that may be employed in an embodiment of the present disclosure.

In FIG. 9, a central processing unit (CPU) 901 executes various processes according to a program stored in a read only memory (ROM) 902 or a program loaded from a storage section 908 to a random access memory (RAM) 903. In the RAM 903, data required when the CPU 901 executes various processes and the like is also stored as necessary. The central processing unit which is only exemplary, may also be other types of processors, such as the processors described above. The ROM 902, the RAM 903, and the storage section 908 may be various forms of computer-readable storage media, as described below. It should be noted that although the ROM 902, the RAM 903, and the storage section 908 are shown in FIG. 9 respectively, one or more of them may be combined or located in the same or different memories or storage modules.

The CPU 901, the ROM 902, and the RAM 903 are connected to each other via a bus 904. The input/output interface 905 is also connected to the bus 904.

The following components are connected to the input/output interface 905: an input section 906, such as a touch screen, a touch panel, a keyboard, a mouse, an image sensor, a microphone, an accelerometer, gyroscope, or the like; an output section 907, comprising a display, such as a cathode ray tube (CRT), a liquid crystal display (LCD), a speaker, a vibrator, or the like; a storage section 908, comprising a hard disk, and a tape; and a communication section 909, comprising a network interface card such as a LAN card and a modem. The communication section 909 allows execution of communication processing via a network such as Internet. It is easily conceivable that, although the devices or modules in the electronic device 900 shown in FIG. 9 communicate through the bus 904, they may also communicate through a network or other means, wherein the network may comprise a wireless network, a wired network, and/or any combination of a wireless network and a wired network.

The driver 910 is also connected to the input/output interface 905 as required. A removable medium 911 such as a magnetic disk, an optical disk, a magneto-optical disk or a semiconductor memory is mounted on the drive 910 as necessary, so that the computer program read out therefrom is installed into the storage section 908 as necessary.

In a case of implementing the above-described series of processes by software, the program constituting a software may be installed from a network such as Internet or a storage medium such as a removable medium 911.

According to the embodiment of the present disclosure, the process described above with reference to the flow chart may be implemented as a computer software program. For example, in the embodiment of the present disclosure, a computer program product is comprised, which comprises a computer program carried on a computer-readable medium, wherein the computer program contains program codes for performing the method shown in the flow chart. In such embodiment, the computer program may be downloaded and installed from the network through the communication section 909, installed from the storage section 908, or installed from the ROM 902. When the computer program is executed by the CPU 901, the above-described functions defined in the method of the embodiment of the present disclosure are executed.

It should be noted that in the context of the present disclosure, a computer-readable medium may be a tangible medium, which may contain or store a program for use by the instruction execution system, apparatus, or device or use in combination with the instruction execution system, apparatus, or device. The computer-readable medium may be a computer-readable signal medium, a computer-readable storage medium or any combination thereof. The computer-readable storage medium may be, for example, but is not limited to: an electrical, magnetic, optical, electromagnetic, infrared, or semiconductor system, device, or apparatus, or a combination thereof. More specific examples of the computer-readable storage medium may comprise, but is not limited to: an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, a computer-readable storage medium may be any tangible medium that contains or stores a program which may be used by an instruction execution system, apparatus, or device or used in combination therewith. In the present disclosure, the computer-readable signal medium may comprise a data signal propagated in a baseband or as a part of a carrier wave, wherein a computer-readable program code is carried. Such propagated data signal may take many forms, comprising but not limited to an electromagnetic signal, an optical signal, or any suitable combination thereof. The computer-readable signal medium may also be any computer-readable medium other than the computer-readable storage medium. The computer-readable signal medium may send, propagate, or transmit a program for use by an instruction execution system, apparatus, or device or in combination with therewith. The program code contained on the computer-readable medium may be transmitted by any suitable medium, comprising but not limited to: a wire, an optical cable, radio frequency (RF), or the like, or any suitable combination thereof.

The above-described computer-readable medium may be comprised in the above-described electronic device; or may also exist alone without being assembled into the electronic device.

In some embodiments, a computer program is also provided. The computer program comprises instructions, which, when executed by a processor, cause the processor to perform the method of any of the above-described embodiments. For example, the instructions may be embodied as a computer program code.

In an embodiment of the present disclosure, the computer program code for performing the operations of the present disclosure may be written in one or more programming languages or a combination thereof. The above-described programming languages comprise but are not limited to object-oriented programming languages, such as Java, Smalltalk, and C++, and also comprise conventional procedural programming languages, such as “C” language or similar programming languages. The program code may be executed entirely on the user's computer, partly on the user's computer, executed as an independent software package, partly on the user's computer and partly executed on a remote computer, or entirely executed on the remote computer or server. In a case of a remote computer, the remote computer may be connected to the user's computer through any kind of network (comprising a local area network (LAN) or a wide area network (WAN)), or may be connected to an external computer (for example, connected through Internet using an Internet service provider).

The flowcharts and block views in the accompanying drawings illustrate the possibly implemented architectures, functions, and operations of the system, method, and computer program product according to various embodiments of the present disclosure. In this regard, each block in the flowchart or block view may represent a module, a program segment, or a part of code, wherein the module, the program segment, or the part of code contains one or more executable instructions for realizing a specified logic function. It should also be noted that, in some alternative implementations, the functions marked in the block may also occur in a different order from the order marked in the accompanying drawings. For example, two blocks shown in succession which may actually be executed substantially in parallel, may sometimes also be executed in a reverse order, depending on the functions involved. It should also be noted that each block in the block view and/or flowchart, and a combination of the blocks in the block view and/or flowchart, may be implemented by a dedicated hardware-based system that performs the specified functions or operations, or may be implemented by a combination of dedicated hardware and computer instructions.

The modules, components, or units involved in the described embodiments of the present disclosure may be implemented in software or hardware. The names of the modules, components or units do not constitute a limitation on the modules, components or units themselves under certain circumstances.

The functions described hereinabove may be performed at least in part by one or more hardware logic components. For example, without limitation, the exemplary hardware logic components that may be used comprise: a Field Programmable Gate Array (FPGA), an Application Specific Integrated Circuit (ASIC), an Application Specific Standard Product (ASSP), a System on Chip (SOC), a Complex Programmable Logical device (CPLD) or the like.

According to some embodiments of the present disclosure, a method for obtaining a recommended explanation is provided. The method comprises: generating a recommended item by a recommendation model; calculating a similarity between a plurality of explanatory items and the recommended item; obtaining a predetermined number of explanatory items from the plurality of explanatory items, as a recommended explanation of the recommended item, wherein a similarity between the predetermined number of explanatory items and the recommended item is greater than a similarity between other explanatory items and the recommended item; and outputting identification information of the predetermined number of explanatory items.

In some embodiments, the calculating of the similarity between the plurality of explanatory items and the recommended item comprises: characterizing the similarity between the plurality of explanatory items and the recommended item by a counterfactual proximity.

In some embodiments, the method further comprises: before calculating the similarity between the plurality of explanatory items and the recommended item, removing at least a portion of the plurality of explanatory items from a training set, and training the recommendation model by remaining items in the training set; calculating a loss function value of the recommendation model during each training process; and determining a recommendation model with a smallest loss function value as a trained recommendation model.

In some embodiments, the characterizing of the similarity between the plurality of explanatory items and the recommended item by the counterfactual proximity comprises: calculating the counterfactual proximity P_{c} between the plurality of explanatory items and the recommended item by the trained recommendation model:

$${P}_{C} = {max}_{j ∈ I \backslash \{ i \}} f ( j ; {θ}^{′} ) - f ( i ; {θ}^{′} ) ,$$

wherein i is the recommended item, I is a set of all items in a system where the recommendation model is located, I\{i} is a set of remaining items in the set I of all items except the recommended item i, f(j; θ′) is a predicted recommendation score for an item j calculated by a recommendation model θ′, f(i; θ′) is a predicted recommendation score for an item i calculated by the recommendation model θ′, and θ′ is the trained recommendation model.

In some embodiments, the obtaining of the predetermined number of explanatory items from the plurality of explanatory items comprises: in response to the predetermined number |E_{u,i}| of the explanatory items being fixed, traversing C_{|I}_{ᵤ}_{|}^{E}^{_{u,i}}^{|} combinations of explanatory items, calculating the counterfactual proximity corresponding to each combination of explanatory items, and obtaining a combination of explanatory items with a largest counterfactual proximity, wherein Iᵤ is the set of all items that an user u interacts with, and E_{u,i} is a set of a part of the items that the user interacts with.

In some embodiments, the calculating of the similarity between the plurality of explanatory items and the recommended item comprises: obtaining a feature vector of each of the plurality of explanatory items and a feature vector of the recommended item from the recommendation model; calculating a Euclidean distance between the feature vector of each of the plurality of explanatory items and the feature vector of the recommended item; selecting a fixed number of explanatory items from the plurality of explanatory items as a candidate explanatory item set, wherein a Euclidean distance between a feature vector of each of explanatory items in the candidate explanatory item set and the feature vector of the recommended item is less than a Euclidean distance between a feature vector of each of explanation items other than the candidate explanatory item set in the plurality of explanatory items and the feature vector of the recommended item; and calculating the counterfactual proximity between explanatory items in the candidate explanatory item set and the recommended item by the trained recommendation model.

In some embodiments, the obtaining of the predetermined number of explanatory items from the plurality of explanatory items comprises: in response to the predetermined number |E_{u,i}| of the explanatory items being fixed, traversing C_{I}_{_{c}}_{|}^{E}^{_{u,i}}^{|} combinations of explanatory items, calculating the counterfactual proximity corresponding to each combination of explanatory items, and obtaining a combination of explanatory items with a largest counterfactual proximity, wherein I_{c} is the candidate explanatory item set, and E_{u,i} is a set of a part of the items that the user interacts with.

In some embodiments, the method further comprises: outputting a maximum value of the counterfactual proximity.

In some embodiments, the method further comprises: outputting the similarity between the predetermined number of explanatory items and the recommended item.

In some embodiments, the calculating of the similarity between the plurality of explanatory items and the recommended item comprises: obtaining a feature vector of each of the plurality of explanatory items and a feature vector of the recommended item from the recommendation model; and calculating a Euclidean distance between the feature vector of each of the plurality of explanatory items and the feature vector of the recommended item, the similarity between the each of the plurality of explanatory items and the recommended item being characterized by the Euclidean distance, wherein the less the Euclidean distance, the greater the similarity.

In some embodiments, the obtaining of the predetermined number of explanatory items from the plurality of explanatory items comprises: selecting the predetermined number of explanatory items from the plurality of explanatory items, wherein a Euclidean distance between a feature vector of each of the predetermined number of explanatory items and the feature vector of the recommended item is less than a Euclidean distance between a feature vector of each of other explanatory items and the feature vector of the recommended item.

In some embodiments, the outputting of the similarity between the predetermined number of explanatory items and the recommended item comprises: calculating an average of Euclidean distances between feature vectors of the predetermined number of explanatory items and the feature vector of the recommended item; and outputting the average of Euclidean distances.

In some embodiments, the similarity between the plurality of explanatory items and the recommended item comprises: a similarity between tags of the plurality of explanatory items and a tag of the recommended item, a similarity between features of the plurality of explanatory items and a feature of the recommended item, a similarity between reviews of the plurality of explanatory items and a review of the recommended item, or a similarity of user feedback information of the plurality of explanatory items and user feedback information of the recommended item.

According to other embodiments of the present disclosure, a device for obtaining a recommended explanation is provided. The device comprises: a generation unit configured to generate a recommended item by a recommendation model; a calculation unit configured to calculate a similarity between a plurality of explanatory items and the recommended item; an obtaining unit configured to obtain a predetermined number of explanatory items from the plurality of explanatory items, as a recommended explanation of the recommended item, wherein a similarity between the predetermined number of explanatory items and the recommended item is greater than a similarity between other explanatory items and the recommended item; and an output unit configured to output identification information of the predetermined number of explanatory items.

According to other embodiments of the present disclosure, an electronic device is provided. The device comprises: a memory; a processor coupled to the memory having stored therein instructions that, when executed by the processor, cause the electronic device to perform the method according to any one of the embodiments in the present disclosure.

According to other embodiments of the present disclosure, a computer readable storage medium is provided. The storage medium has stored thereon a computer program which, when executed by a processor, implements the method according to any one of the embodiments in the present disclosure.

According to still other embodiments of the present disclosure, a computer program is provided. The computer program comprises: instructions that, when executed by a processor, cause the processor to perform the method according to any one of the embodiments in the present disclosure.

According to still other embodiments of the present disclosure, a computer program product is provided. The computer program product comprises: instructions that, when executed by a processor, implement the method according to any one of the embodiments in the present disclosure.

The above description is only an explanation of some embodiments of the present disclosure and the applied technical principles. Those skilled in the art should understand that the scope of disclosure involved in the present disclosure is not limited to the technical solutions formed by the specific combination of the above technical features, and at the same time should also cover other technical solutions formed by arbitrarily combining the above-described technical features or equivalent features without departing from the above disclosed concept. For example, the above-described features and the technical features disclosed in the present disclosure (but not limited thereto) having similar functions are replaced with each other to form a technical solution.

In the description provided herein, many specific details are elaborated. However, it is understood that the embodiments of the present disclosure may be implemented without these specific details. In other cases, in order not to obscure the understanding of the description, the well-known methods, structures and technologies are not demonstrated in detail.

In addition, although the operations are depicted in a specific order, this should not be understood as requiring these operations to be performed in the specific order shown or performed in a sequential order. Under certain circumstances, multitasking and parallel processing might be advantageous. Likewise, although several specific implementation details are contained in the above discussion, these should not be construed as limiting the scope of the present disclosure. Certain features that are described in the context of individual embodiments may also be implemented in combination in a single embodiment. On the contrary, various features described in the context of a single embodiment may also be implemented in multiple embodiments individually or in any suitable sub-combination.

Although some specific embodiments of the present disclosure have been described in detail by way of examples, those skilled in the art should understand that the above examples are only for an illustrative purpose, rather than limiting the scope of the present disclosure. It should be understood by those skilled in the art that modifications to the above embodiments may be made without departing from the scope and spirit of the present disclosure. The scope of the present disclosure is defined by the appended claims.

What is claimed is:

1. A method for obtaining a recommended explanation, comprising:
generating a recommended item by a recommendation model;
calculating a similarity between a plurality of explanatory items and the recommended item;
obtaining a predetermined number of explanatory items from the plurality of explanatory items, as a recommended explanation of the recommended item, wherein a similarity between the predetermined number of explanatory items and the recommended item is greater than a similarity between other explanatory items and the recommended item; and
outputting identification information of the predetermined number of explanatory items.

2. The method according to claim 1, wherein the calculating of the similarity between the plurality of explanatory items and the recommended item comprises:
characterizing the similarity between the plurality of explanatory items and the recommended item by a counterfactual proximity.

3. The method according to claim 2, further comprising:
before calculating the similarity between the plurality of explanatory items and the recommended item, removing at least a portion of the plurality of explanatory items from a training set, and training the recommendation model by remaining items in the training set;
calculating a loss function value of the recommendation model during each training process; and
determining a recommendation model with a smallest loss function value as a trained recommendation model.

4. The method according to claim 3, wherein the characterizing of the similarity between the plurality of explanatory items and the recommended item by the counterfactual proximity comprises:
calculating the counterfactual proximity P_{c} between the plurality of explanatory items and the recommended item by the trained recommendation model:
$${P}_{C} = {max}_{j ∈ I \backslash \{ i \}} f ( j ; {θ}^{′} ) - f ( i ; {θ}^{′} ) ,$$
wherein i is the recommended item, I is a set of all items in a system where the recommendation model is located, I\{i} is a set of remaining items in the set I of all items except the recommended item i, f(j; θ′) is a predicted recommendation score for an item j calculated by a recommendation model θ′, f(i; θ′) is a predicted recommendation score for an item i calculated by the recommendation model θ′, and θ′ is the trained recommendation model.

5. The method according to claim 4, wherein the obtaining of the predetermined number of explanatory items from the plurality of explanatory items comprises:
in response to the predetermined number |E_{u,i}| of the explanatory items being fixed, traversing C_{|I}_{ᵤ}_{|}^{|E}^{_{u,i}}^{|} combinations of explanatory items, calculating the counterfactual proximity corresponding to each combination of explanatory items, and obtaining a combination of explanatory items with a largest counterfactual proximity, wherein Iᵤ is the set of all items that an user u interacts with, and E_{u,i} is a set of a part of the items that the user interacts with.

6. The method according to claim 3, wherein the calculating of the similarity between the plurality of explanatory items and the recommended item comprises:
obtaining a feature vector of each of the plurality of explanatory items and a feature vector of the recommended item from the recommendation model;
calculating a Euclidean distance between the feature vector of each of the plurality of explanatory items and the feature vector of the recommended item;
selecting a fixed number of explanatory items from the plurality of explanatory items as a candidate explanatory item set, wherein a Euclidean distance between a feature vector of each of explanatory items in the candidate explanatory item set and the feature vector of the recommended item is less than a Euclidean distance between a feature vector of each of explanation items other than the candidate explanatory item set in the plurality of explanatory items and the feature vector of the recommended item; and
calculating the counterfactual proximity between explanatory items in the candidate explanatory item set and the recommended item by the trained recommendation model.

7. The method according to claim 6, wherein the obtaining of the predetermined number of explanatory items from the plurality of explanatory items comprises:
in response to the predetermined number |E_{u,i}| of the explanatory items being fixed, traversing C_{|I}_{_{c}}_{|}^{|E}^{_{u,i}}^{|} combinations of explanatory items, calculating the counterfactual proximity corresponding to each combination of explanatory items, and obtaining a combination of explanatory items with a largest counterfactual proximity, wherein I_{c} is the candidate explanatory item set, and E_{u,i} is a set of a part of the items that the user interacts with.

8. The method according to claim 5, further comprising:
outputting a maximum value of the counterfactual proximity.

9. The method according to claim 1, further comprising:
outputting the similarity between the predetermined number of explanatory items and the recommended item.

10. The method according to claim 9, wherein the calculating of the similarity between the plurality of explanatory items and the recommended item comprises:
obtaining a feature vector of each of the plurality of explanatory items and a feature vector of the recommended item from the recommendation model; and
calculating a Euclidean distance between the feature vector of each of the plurality of explanatory items and the feature vector of the recommended item, the similarity between the each of the plurality of explanatory items and the recommended item being characterized by the Euclidean distance, wherein the less the Euclidean distance, the greater the similarity.

11. The method according to claim 10, wherein the obtaining of the predetermined number of explanatory items from the plurality of explanatory items comprises:
selecting the predetermined number of explanatory items from the plurality of explanatory items, wherein a Euclidean distance between a feature vector of each of the predetermined number of explanatory items and the feature vector of the recommended item is less than a Euclidean distance between a feature vector of each of other explanatory items and the feature vector of the recommended item.

12. The method according to claim 11, wherein the outputting of the similarity between the predetermined number of explanatory items and the recommended item comprises:
calculating an average of Euclidean distances between feature vectors of the predetermined number of explanatory items and the feature vector of the recommended item; and
outputting the average of Euclidean distances.

13. The method according to claim 1, wherein the similarity between the plurality of explanatory items and the recommended item comprises:
a similarity between tags of the plurality of explanatory items and a tag of the recommended item, a similarity between features of the plurality of explanatory items and a feature of the recommended item, a similarity between reviews of the plurality of explanatory items and a review of the recommended item, or a similarity of user feedback information of the plurality of explanatory items and user feedback information of the recommended item.

14. (canceled)

15. An electronic device, comprising:
a memory; and
a processor coupled to the memory having stored therein instructions that, when executed by the processor, cause the electronic device to:
generate a recommended item by a recommendation model;
calculate a similarity between a plurality of explanatory items and the recommended item;
obtain a predetermined number of explanatory items from the plurality of explanatory items, as a recommended explanation of the recommended item, wherein a similarity between the predetermined number of explanatory items and the recommended item is greater than a similarity between other explanatory items and the recommended item; and
output identification information of the predetermined number of explanatory items.

16. A non-transitory computer readable storage medium having stored thereon computer program which, when executed by a processor, causes the processor to:
generate a recommended item by a recommendation model;
calculate a similarity between a plurality of explanatory items and the recommended item;
obtain a predetermined number of explanatory items from the plurality of explanatory items, as a recommended explanation of the recommended item, wherein a similarity between the predetermined number of explanatory items and the recommended item is greater than a similarity between other explanatory items and the recommended item; and
output identification information of the predetermined number of explanatory items.

17. (canceled)

18. The electronic device according to claim 15, wherein the instructions, when executed by the processor, cause the electronic device to characterize the similarity between the plurality of explanatory items and the recommended item by a counterfactual proximity.

19. The electronic device according to claim 18, wherein the instructions, when executed by the processor, further cause the electronic device to:
before calculating the similarity between the plurality of explanatory items and the recommended item, remove at least a portion of the plurality of explanatory items from a training set, and train the recommendation model by remaining items in the training set;
calculate a loss function value of the recommendation model during each training process; and
determine a recommendation model with a smallest loss function value as a trained recommendation model.

20. The electronic device according to claim 19, wherein the instructions, when executed by the processor, cause the electronic device to calculate the counterfactual proximity P_{c} between the plurality of explanatory items and the recommended item by the trained recommendation model:
$${P}_{C} = {max}_{j ∈ I \backslash \{ i \}} f ( j ; {θ}^{′} ) - f ( i ; {θ}^{′} ) ,$$
wherein i is the recommended item, I is a set of all items in a system where the recommendation model is located, I\{i} is a set of remaining items in the set I of all items except the recommended item i, f(j; θ′) is a predicted recommendation score for an item j calculated by a recommendation model θ′, f(i; θ′) is a predicted recommendation score for an item i calculated by the recommendation model θ′, and θ′ is the trained recommendation model.

21. The non-transitory computer readable storage medium according to claim 16, wherein the computer program, when executed by a processor, causes the processor to characterize the similarity between the plurality of explanatory items and the recommended item by a counterfactual proximity.

22. The non-transitory computer readable storage medium according to claim 21, wherein the computer program, when executed by a processor, further causes the processor to:
before calculating the similarity between the plurality of explanatory items and the recommended item, remove at least a portion of the plurality of explanatory items from a training set, and train the recommendation model by remaining items in the training set;
calculate a loss function value of the recommendation model during each training process; and
determine a recommendation model with a smallest loss function value as a trained recommendation model.
